(19) United States
(12) Patent Application Publication
(10) Pub. No.: US 2025/0028048 A1
(43) Pub. Date: Jan. 23, 2025

(54) METHOD AND APPARATUS FOR GREENHOUSE GAS EMISSION MANAGEMENT

(71) Applicant: Cameron International Corporation, Houston, TX (US)

(72) Inventors: Andrew Emil Pomerantz, Lexington, MA (US); Andrew J. Speck, Milton, MA (US); Kahina Abdeli-Galinier, London (GB); Charles Toussaint, Clamart (FR); Karl Staffan Tekin Eriksson, London (GB); Thibault Vexiau, Clamart (FR); Sebastien Catheline, Clamart (FR); Gokhan Erol, Sugar Land, TX (US); Lukasz Zielinski, Cambridge, MA (US)

(21) Appl. No.: 18/714,856

(22) PCT Filed: Jan. 10, 2023
(86) PCT No.: PCT/US2023/010475

§ 371 Date: May 30, 2024

Related U.S. Application Data
(60) Provisional application No. 63/266,606, filed on Jan. 10, 2022.
(60) Provisional application No. 63/266,605, filed on Jan. 10, 2022.
(60) Provisional application No. 63/269,682, filed on Mar. 21, 2022.

(51) Int. Cl. G01S 17/58; B64U 20/80

(52) U.S. Cl. CPC G01S 17/58; B64U 20/80

(57) ABSTRACT

A method includes receiving an indication of an emission plume traveling along a first direction. The method also includes determining a cross-section of the emission plume, wherein the cross-section is substantially perpendicular to the first direction. Further, the method includes determining a travel path for an optical detector to obtain optical measurements along the cross-section, wherein the travel path extends in a second direction along the cross-section, and the optical detector is configured to obtain the optical measurements in a third direction crosswise to the travel path.

### RELATED APPLICATIONS

This application claims priority to U.S. Provisional Application Ser. No. 63/266,606, titled “Method and Apparatus for Greenhouse Gas Emission Management”, which was filed on Jan. 10, 2022, U.S. Provisional Application Ser. No. 63/266,605, titled “Method and Apparatus for Greenhouse Gas Emission Management”, which was filed on Jan. 10, 2022, and U.S. Provisional Application Ser. No. 63/269,682, titled “Optimized Multi-stage Methane Inspection of a Facility Using Mobile Lidar”, which was filed on Mar. 21, 2022, and which are herein incorporated by reference in their entirety for all purposes.

### BACKGROUND

The subject matter disclosed herein relates to systems and methods for determining a travel path for an optical detector. More specifically, the subject matter disclosed herein relates to systems and methods for determining a travel path to obtain optical measurements with one or more vehicles.

Methane is a relatively potent greenhouse gas and the main component of natural gas. The process of extracting and processing natural gas inevitably results in some methane emissions, and those emissions lead to global warming, contributing significantly to climate change. As such, operators in upstream/midstream oil and gas are interested in reducing methane emissions from their facilities. Such emissions arise from a range of facilities (e.g., single wells to gas plant), sources (e.g., intentional vents to unintentional fugitive leaks), and equipment (e.g., tanks, compressors, separators, pneumatic controllers, and so forth). Thus, methane emissions can be reduced by a variety of technologies including leak detection, leak repair, venting elimination, and data management.

Drones may be used to measure methane emissions. The drones include relatively short-range copters as well as relatively long-range fixed-wings, and the drones are deployed onshore and offshore. The drones include remotely piloted systems within line of sight of the operator or beyond to completely autonomous operation. The drones may be equipped with a methane point sensor or an optical gas imaging camera. These systems have some disadvantages. For example, systems with point sensors may be relatively slow, as the drone needs to fly to many locations surround the site to measure concentration at different elevations, upwind vs downwind, etc. Further, systems with optical gas imaging cameras are not quantitative. As such, there is a need to provide efficient techniques for collecting and analyzing an emission plume emission to reduce time, and thus computational resources, to determine properties of the emission plume emission.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, the present disclosure relates to a method. The method includes receiving an indication of an emission plume traveling along a first direction. The method also includes determining a cross-section of the emission plume, wherein the cross-section is substantially perpendicular to the first direction. Further, the method includes determining a travel path for an optical detector to obtain optical measurements along the cross-section, wherein the travel path extends in a second direction along the cross-section, and the optical detector is configured to obtain the optical measurements in a third direction crosswise to the travel path.

In certain embodiments, the present disclosure relates to a system. The system includes one or more vehicles and a processor that instructs one or more vehicles to execute a travel path along a length of the cross-section of an emission plume. The processor may also instruct the one or more vehicles to obtain optical measurements along a width of the cross-section during the travel path. Further, the processor may receive the optical measurements. Further still, the processor may determine an emission rate corresponding to the emission plume based on the optical measurements.

In certain embodiments, the present disclosure relates to a system. The system includes one or more unmanned vehicles and a processor that receives an indication of an emission plume traveling along a first direction. The processor may also determine a cross-section corresponding to a cross-section of the emission plume, wherein the cross-section is substantially perpendicular to the first direction. Further, the processor may instruct a controller of the one or more unmanned vehicles to execute a travel path along a length of the cross-section and obtain optical measurements along a width of the cross-section during the travel path. Even further, the processor may receive the optical measurements. Further still, the processor may generate an emission plume property output indicative of a concentration of one or more gases within the emission plume.

### BRIEF DESCRIPTION OF THE DRAWINGS

Various aspects of this disclosure may be better understood upon reading the following detailed description and upon reference to the drawings in which:

FIG. 1 is a schematic diagram of an embodiment of a facility that may emit an emission plume;

FIG. 2 is a block diagram of an emission plume monitoring system and a vehicle controller;

FIG. 3A is a perspective view of a first area surrounding the facility in FIG. 1;

FIG. 3B is a perspective view of a second area surrounding the facility in FIG. 1;

FIG. 4 is a perspective view of an emission plume emitted from the facility in FIG. 1;

FIG. 5 is a graph depicting a measurement plane for determining one or more properties of an emission plume;

FIG. 6 is a flow diagram of an embodiment of a process for determining a travel path for an optical detector;

FIG. 7 is a flow diagram of an embodiment of a process for generating an emission plume property output based on optical measurements; and

FIG. 8 is a flow diagram of an embodiment of a process for instructing multiple vehicles to obtain optical measurements.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the terms “real time”, “real-time”, or “substantially real time” may be used interchangeably and are intended to described operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic” and “automated” are intended to describe operations that are performed are caused to be performed, for example, by a greenhouse gas emission analysis system (i.e., solely by the greenhouse gas emission analysis system, without human intervention). As referred to herein, vectors or directions that are “substantially parallel” are within a first angular offset (e.g., between −45° and 45°, between −35° and 35°, between −25° and 25°, or between −15° and 15°). As referred to herein, vectors or directions that are “substantially perpendicular” are within a second angular offset (e.g., between 45° and 135°, between 55° and 125°, between 75° and 115°, or between 80° and 100°).

As described above, it may be advantageous to measure certain gas emissions, such as methane (CH₄), carbon dioxide (CO₂), or other greenhouse gas emissions, to monitor an amount of the gas being emitted into the air, identify leaks and/or otherwise control (e.g., reduce or prevent) gas from being emitted into the air. Certain techniques utilize aircraft, such as drones, or planes fitted with detectors to acquire or otherwise record optical measurements indicating a concentration of the gas. However, determining the concentration of the gas may be difficult as the gas continuously diffuses into a surrounding environment. For example, wind moving against an emission plume causes the gas to diffuse relatively quickly into the environment. Accordingly, it may be difficult to accurately determine the concentration of the gases.

Accordingly, the present disclosure is directed to improved techniques for measuring properties of an emission plume, such as the composition and/or flux of the emission plume. For example, the disclosed techniques include determining a travel path for one or more light detection units including a light source and/or a light detector. In general, the travel path provides for efficient optical measurements by the light detection unit and, ultimately processing of the optical measurements by reducing the amount of data acquired by certain conventional techniques. For example, the travel path is a direction of travel for a vehicle (e.g., a land vehicle, an aerial vehicle, unmanned or manned) that is along a dimension of a plane, cross-section, or otherwise a surface that is crosswise to a direction of flow or diffusion of the emission plume. The travel path may refer to the path of travel of one or more light detectors of a vehicle as the vehicle moves along a ground travel path (or ground path) for a land vehicle and an aerial travel path (or travel path) for an aerial vehicle. For example, the travel path may be along a cross-section of the emission plume. The light detection unit may be mounted onto, coupled to, or otherwise integrated with a vehicle, or a mast of the vehicle. In operation, the vehicle moves along the travel path and the light detection unit is oriented to record optical measurements along a dimension of the plane that is crosswise to the travel path and towards a reflective surface (e.g., that reflects light transmitted by the light source back towards the light detector of the vehicle) and/or an external light detector (e.g., coupled to another vehicle, or disposed on a ground or a component of a facility such as the walls or equipment that may contain gas). As such, recording the optical measurements at different positions along the travel path and along the dimension crosswise to the travel path, generates data indicating optical properties (e.g., absorption) of the cross-section of the emission plume. The optical measurements may include absorption measurements corresponding to one or more chemical species (i.e., CO₂ and/or methane). As such, the optical measurements corresponding to the cross-section indicate the concentration of species within the cross-section and/or a flux of the chemical species in the emission plume. As described herein, it may be advantageous that the travel path is substantially horizontal to the ground. Further, it may be advantageous to orient the optical measurements towards the ground, or vertically. In this way, by obtaining continuous optical measurements along a vertical dimension, the resulting optical measurements corresponding to the cross-section (e.g., the cross-section of the emission plume) is not subject to grating effects that may result from diffusion of the gases during the measurement time period.

It should be noted that, although the discussion herein is generally directed to methane and/or CO₂, it may be advantageous to apply the disclosed techniques to other systems. For example, the techniques may be applied to a CO₂ imager for CO₂ sequestration plants, performing dual dip measurements (e.g., both carbon monoxide (CO) and CO₂) in the near infrared (NIR), quantifying methane and other hydrocarbons, imaging hydrogen sulfide (H₂S), imaging ethane, and other applications where it may be useful to image a fluid or gas.

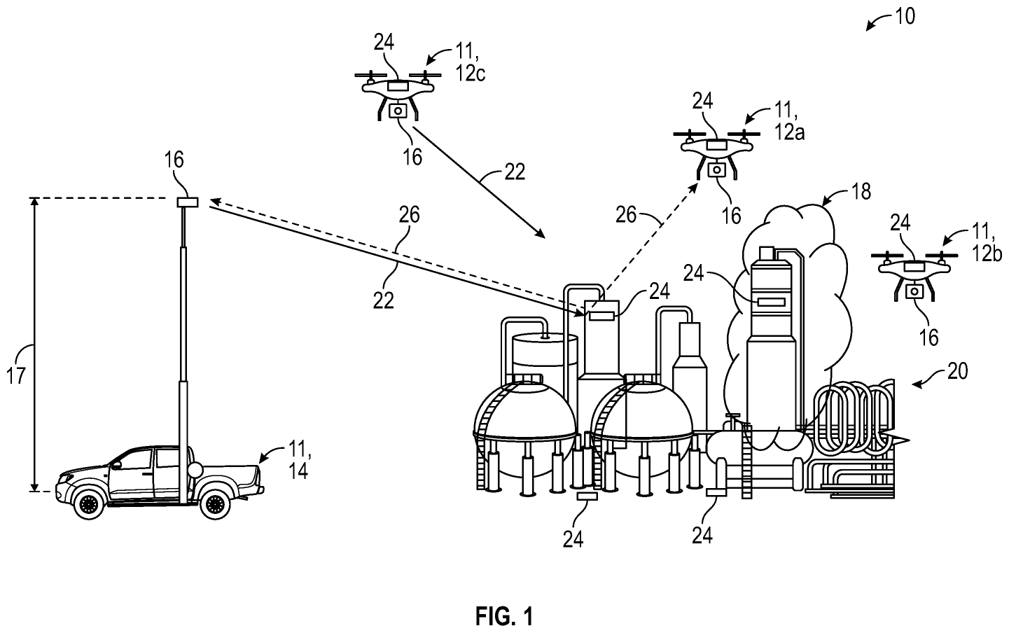

With the foregoing in mind, FIG. 1 is a schematic diagram of an embodiment of a facility that may emit an emission plume. More specifically, FIG. 1 illustrates an embodiment of a gas emission detection system 10 that includes multiple vehicles 11, such as aerial vehicles 12a, 12b, and 12c, collectively aerial vehicles 12. In general, the aerial vehicles 12 may include aerial drones or other unmanned aerial vehicles (UAVs). For example, the aerial vehicles 12 may include relatively short-range copters as well as relatively long-range fixed-wings and can be deployed onshore and offshore. The aerial vehicles 12 may include remotely piloted systems within line of sight of the operator or beyond, or the aerial vehicles 12 may include completely autonomous systems.

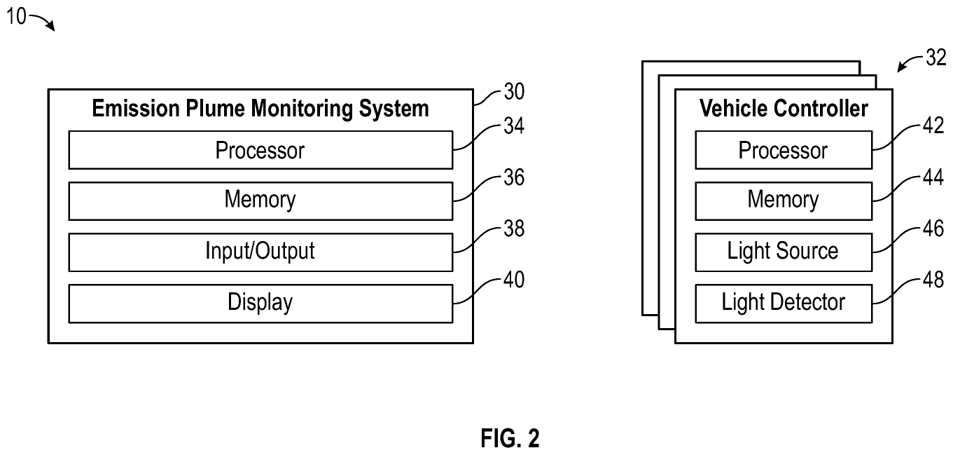

Additionally, the illustrated embodiment of the gas emission detection system 10 includes vehicles 11 that are land vehicles 14. The land vehicles 14 may include unmanned ground vehicles (UGVs), such as UGVs having wheels, tracks, or legs, and other ground based autonomous vehicles and/or surface vessels offshore. As illustrated, the aerial vehicles 12 and the land vehicles 14 include a light detection unit 16. For example, the light detection unit 16 may be mounted on a mast 17 (e.g., pole or other elevated structure) that enables the light detection unit 16 to record optical measurements at a relatively higher altitude or height than may be obtainable without the mast 17. In general, the light detection unit 16 may include a light detector and/or an illumination source as described in FIG. 2. For example, the aerial vehicles 12 may be equipped with a methane point sensor or an optical gas imaging camera. In some embodiments, the light detection unit 16 may include a light detection and ranging (LiDAR) detector. In some embodiments, the light detection unit 16 includes a LiDAR sensor with a single photon detector. In any case, the detector might be lightweight and with low power consumption, which make it amenable to vehicle 11 deployment, for example. The light detection unit 16 may be used to detect certain greenhouse gas emissions, such as methane emissions and/or carbon dioxide emissions, present in an emission plume 18 (e.g., gas plume). In some instances, both methane and carbon dioxide can be detected, enabling an estimate of a flare efficiency. The light detection unit 16 may be used to detect, monitor, or measure one or more properties of the emission plume 18. The emission plume 18 may be emitted or leaked from a facility 20.

The light detection unit 16 generally emits light 22 towards a reflective surface 24 and receives reflected light 26. The reflective surface 24 may be formed directly on equipment at a site (e.g., equipment of the facility 20) and/or the reflective surface 24 may be part of a reflector that can be mounted at the site. The reflective surface 24 is generally a surface having any suitable reflectance to minimize loss of light reflected back to the light detection unit 16. In some embodiments, the reflective surface 24 may be a retroreflective material and/or part of a retroreflector, which may facilitate reflection of the emitted light 22 back to the light detection unit 16 over a wide range of angle of incidence. The reflective surface 24 may be disposed at various positions within the facility 20, on vehicles 11, which may include aerial vehicles 12, and/or on land vehicles 14. In some embodiments, the light detection unit 16 may operate to emit light 22 towards the reflective surface 24 and receive the resulting reflected light 26 at a detector of the light detection unit 16. In some embodiments, the light detection unit 16 may be operated in a passive mode, thereby generating optical measurements and/or image data without a reflector. In some embodiments, a detector of the light detection unit 16 may be a beam splitter that enables multiple measurements (e.g., multiple independent measurements) to remove an effect of dark count.

In certain embodiments, one or more of the vehicles 11 may operate in a cooperative manner to emit and detect light. For example, as illustrated, the light detection unit 16 mounted on the mast 17 of the land vehicle 14 may emit a light 22 that is reflected by a reflective surface 24 disposed on a tank of the facility 20. At least a portion of the reflected light 26 may be directed towards a light detection unit 16 of another vehicle, such as the aerial vehicle 12a. In certain embodiments, multiple land vehicles 14 and/or aerial vehicles 12 may move in cooperative or coordinated paths of travel to collect optical measurements. For example, the light detection unit 16 of a first aerial vehicle 12 may emit light 22 towards an emission plume 18 as the first aerial vehicle 12 moves along a first travel path (e.g., light emission travel path). Certain chemical species within the emission plume 18 may scatter, reflect, or absorb the light (e.g., wavelengths or frequencies of the light corresponding to the chemical species), thereby modifying an intensity of the light. Then, the light detection unit 16 of a second aerial vehicle 12 may detect the modified light or reflected light 22 as the second aerial vehicle 12 moves along a second travel path (e.g., light detection travel path) coordinated or complementary to the first travel path. The coordinated paths of travel also may be achieved between aerial and land vehicles 12 and 14, between multiple land vehicles 14, and/or between any two or more vehicles. It should be noted that multiple vehicles 11 may operate cooperatively with or without a reflective surface 24.

FIG. 2 is a block diagram of a gas emission detection system 10 that includes an emission plume monitoring system 30 and a vehicle controller 32 that may be used to perform certain operations described herein. As illustrated, the emission plume monitoring system 30 includes a processor 34 configured to execute instructions stored in memory 36. The memory 36 may be any suitable article of manufacture that can store the instructions. In some embodiments, the memory 36 is a tangible, non-transitory, machine-readable-medium that may store machine-readable instructions for the processor 34 to execute. The memory 36 may include ROM, flash memory, a hard drive, or any other suitable optical, magnetic, or solid-state storage medium, or a combination thereof. The memory 36 may store data, instructions, and any other suitable information supporting operation of the emission plume monitoring system 30. Additionally, the emission plume monitoring system 30 may include an input/output (I/O) port 38, which may include interfaces coupled to various components such as input devices (e.g., keyboard, mouse), input/output (I/O) modules, sensors (e.g., surface sensors and/or downhole sensors), and the like. Additionally, the emission plume monitoring system 30 includes display 40 (e.g., an electronic display) that may provide a visualization, a well log, or other operating parameters of the facility 20.

As illustrated, the vehicle controller 32 may include generally similar features as the emission plume monitoring system 30. For example, the vehicle controller 32 includes a processor 42 configured to execute instructions stored in memory 44. The memory 44 may be any suitable article of manufacture that can store the instructions. In some embodiments, the memory 44 is a tangible, non-transitory, machine-readable-medium that may store machine-readable instructions for the processor 42 to execute. The memory 44 may include ROM, flash memory, a hard drive, or any other suitable optical, magnetic, or solid-state storage medium, or a combination thereof. The memory 44 may store data, instructions, and any other suitable information supporting operation of the vehicle controller 32.

Additionally, the vehicle controller 32 may include or be coupled to a light source 46 and/or a light detector 48. As described above, the aerial vehicles 12 and/or the land vehicles 14 may include a light detection unit 16. The light detection unit 16 may include the light source 46 and/or the light detector 48. In some embodiments, the light detector 48 may include a LiDAR detector. In some embodiments, the light detector 48 includes a LiDAR sensor with a single photon detector. In any case, the light detector 48 may be lightweight (e.g., less than 10% of the weight of the vehicle 11, less than 5% of the weight of the vehicle 11, less than 2% of the weight of the vehicle 11) and with low power consumption (e.g., less than 30 Watts (W), less than 20 W, or less than 10 W), which makes it amenable to vehicle 11 deployment, for example. The light detector 48 may be used to detect certain greenhouse gas emissions, such as methane emissions and/or carbon dioxide emissions, present in an emission plume 18. In some instances, the light detector 48 is configured to detect both methane and carbon dioxide, enabling an estimate of a flare efficiency.

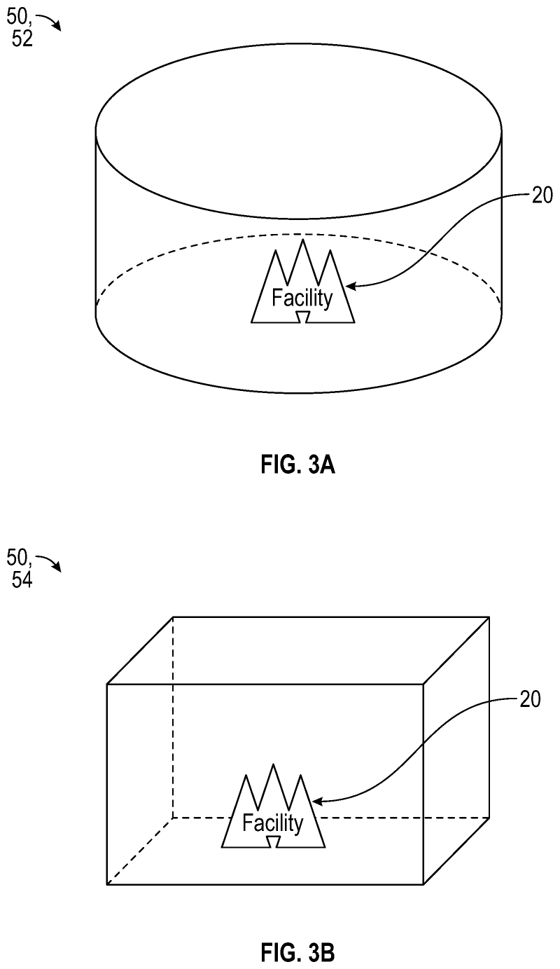

In some embodiments, the disclosed techniques include estimating a total flux of an emission or pollutant of interest (e.g., CH₄ or CO₂) away from the emission source. Flux is the rate of flow of a substance through a given (imaginary) surface. By Gauss's Law, or by simple principle of conservation of matter, the total flux through the cross-section surrounding the emission source will be equal to an emission rate less any accumulation of the pollutant within the volume encompassed by the cross-section. While some pooling of the emitted gases in the emission plume 18 may be possible due to downwash behind buildings, topographical obstacles, and the like, neither methane nor CO₂ may interact with their surroundings on the time scales of interest. As such, in steady-state conditions for a continuous release, the total outflow through the cross-section 64 may be equal to the emission rate. If significant accumulations or pooling of the gasses is suspected, it may be advantageous to estimate the accumulations or pooling to draw emission rate conclusions from the flux measurement. FIG. 3A is a perspective view of a surface boundary 50 of a cylindrical volume 52 surrounding the facility in FIG. 1. FIG. 3B is a perspective view of a surface boundary 50 of a rectangular volume 54 surrounding the facility in FIG. 1.

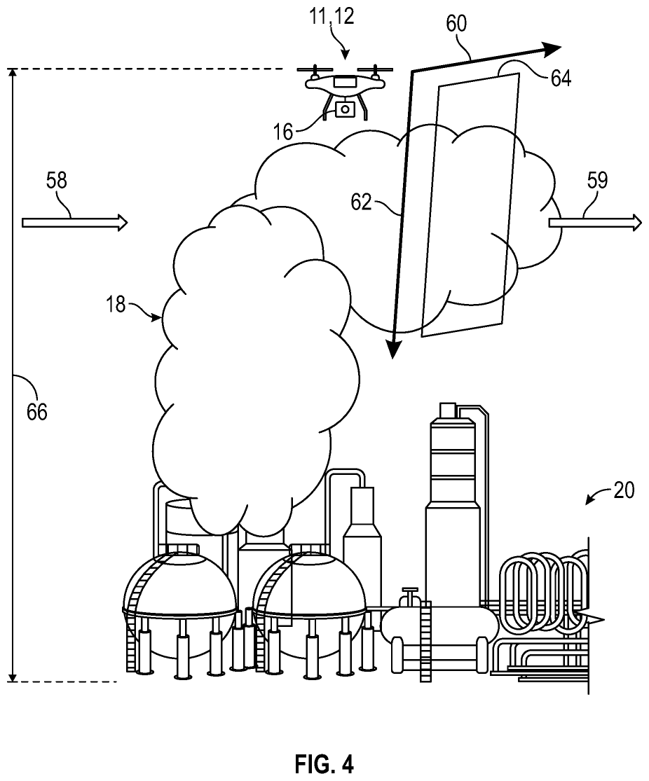

As described herein, it may be advantageous to measure, obtain, or otherwise acquire optical data along a plane that is a cross-section of an emission plume 18. FIG. 4 is a perspective view of the emission plume 18 emitted from the facility 20 in FIG. 1. The illustrated embodiment shows wind (e.g., along the first direction 58) that may cause a portion of the emission plume 18 to move in a second direction 59 that is substantially parallel with the first direction 58 of the wind. To measure one or more properties of the emission plume 18, the aerial vehicle 12 may move along a travel path 60 (e.g., flight path) while recording measurements in a third direction 62 with the light detection unit 16. In general, the travel path 60 may be a direction that is angularly offset from the third direction 62. In some embodiments, the travel path 60 may be in a direction that is crosswise or substantially perpendicular to the third direction 62. That is, the light detection unit 16 may record multiple optical measurements in the third direction 62 at different points along the travel path 60. The travel path 60 and the third direction 62 are vectors that form the cross-section 64 (e.g., an imaginary surface where the optical measurements are obtained). For example, the travel path 60 may define a width of the cross-section 64 and the third direction 62 may define the length of the cross-section 64.

Further, the travel path 60 is at a distance 66 (e.g., vertical distance, height, or elevation) from the facility or ground. As described herein, it may be advantageous to determine the distance 66 corresponding to the location where the emission plume 18 is traveling substantially parallel to the first direction 58 of the wind. That is, when the emission plume 18 is traveling substantially parallel to the first direction 58, a cross-section of the emission plume 18 may have one or more dimensions that are substantially vertical. As such, and by recording optical measurements along the substantially vertical dimension, a reflective surface disposed at the bottom may be used to reflect light emitted by the light detection unit 16 towards a detector of the light detection unit 16.

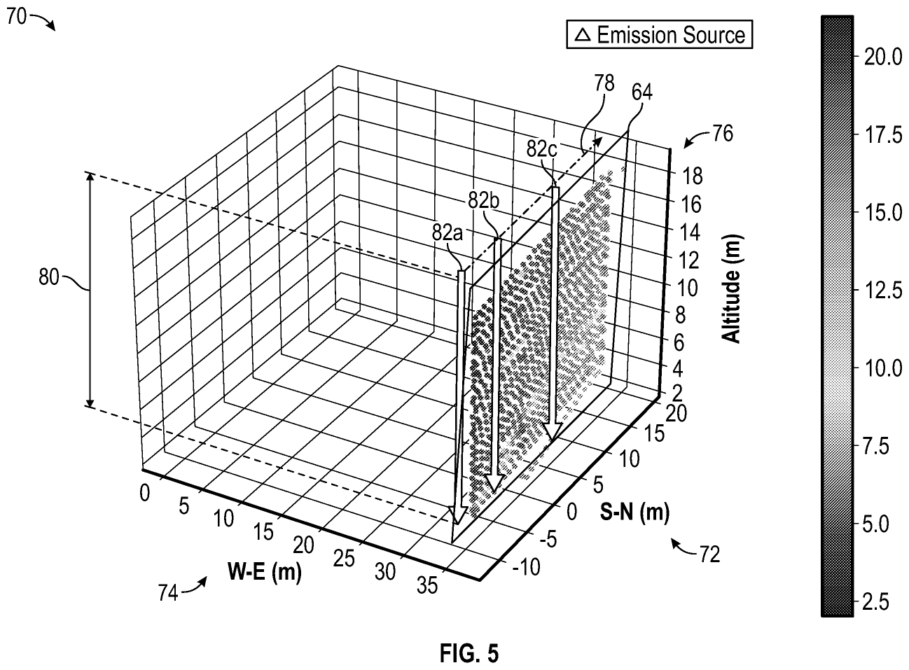

As described above, a light detection unit 16 disposed on the vehicle 11 may record multiple measurements along the direction that is crosswise to a travel path 60 of a vehicle 11 supporting the light detection unit 16. FIG. 5 is a graph 70 depicting an embodiment of a measurement plane for determining one or more properties of an emission plume 18. In general, the graph 70 shows a first axis 72 (e.g., x-axis corresponding to south and north cardinal directions), a second axis 74 (e.g., the y-axis corresponding to west and east cardinal directions), and an altitude 76 (e.g., the z-axis). The graph includes a vector 78 corresponding to the travel path 60. The travel path 60 (i.e. along the vector 78) is at a height 80 above the ground (e.g., at approximately 0 meters (m) along the altitude). Although the travel path 60 is shown as being linear, it should be noted that in other embodiment the travel path may include multiple directions, curved, or include multiple vectors. Further, optical measurement vectors 82 (e.g., 82a, 82b, and 82c) are illustrated that correspond to different optical measurements recorded by the light detection unit 16 as an aerial vehicle 12 including the light detection unit 16 moves along the vector 78. For example, a first optical measurement vector 82a corresponds to a first optical measurement recorded by the light detection unit 16 at a first position along the first axis 72. A second optical measurement vector 82b corresponds to a second optical measurement recorded by the light detection unit 16 at a second position along the first axis 72. A third optical measurement vector 82c corresponds to a third optical measurement recorded by the light detection unit 16 at a third position along the first axis 72. Together, the first optical measurement, the second optical measurement, the third optical measurement, and any additional optical measurements, may be combined to form a two-dimensional data set (e.g., image data or two-dimensional image data) indicating properties of gases within the cross-section 64. In certain embodiments, the optical measurement vectors 82 may include 10s, 100s, or 1000s of optical measurement vectors at any suitable increments in time (e.g., every 1, 2, 3, 4, 5, 6, 7, 8, 9, 10, 20, 30, or more seconds) and/or at any suitable increments in space (e.g., every 1, 2, 3, 4, 5, 6, 7, 8, 9, 10, 20, 30, or more units of distance) along the travel path 60 (i.e., along the vector 78). The units of distance may be centimeters, meters, inches, feet, yards, or other units of distance.

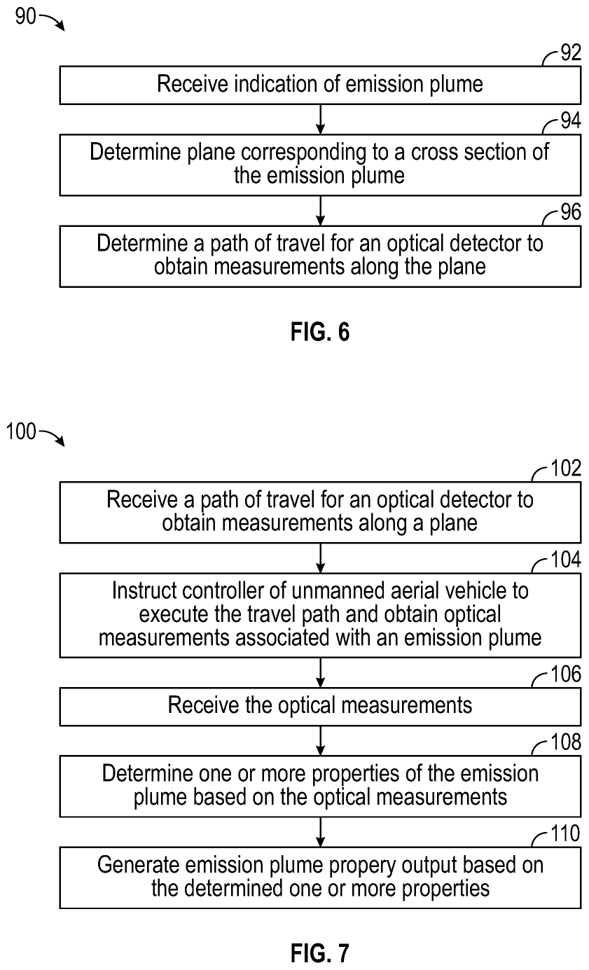

FIG. 6 is a flow diagram of an embodiment of a process 90 for determining a travel path 60 for an optical detector, further illustrating operation of the components of the emission plume monitoring system 30 described in FIG. 2. Although the process 90 is described as being performed by the processor 34, any suitable machine or processor-based device capable of communicating with other components of the system 10 may perform the disclosed process 90 including, but not limited to, the controller 110, and the like. At least in some embodiments, the processor 34 may perform the process 90 with one or more blocks omitted or in a different order.

At block 92, the processor 34 may receive an indication of an emission plume (e.g., emission plume 18). In general, the processor 34 may receive an alert indicating an increase or decrease in pressure, a detected presence of gases corresponding to the emission plume 18, user input, or otherwise, indicative of a presence of undesirable gases within the facility 20.

At block 94, the processor 34 may determine a plane corresponding to a cross-section of the emission plume (e.g., emission plume 18). In general, determining the plane includes determining a location along the emission plume 18 to obtain optical measurements. For example, the plane may be a cross-section (perpendicular or normal to the direction 59) of the emission plume 18 as the emission plume 18 is traveling substantially horizontal as described in FIG. 4. As such, determining the location along the emission plume 18 may include determining a height or altitude where the emission plume 18 is traveling substantially horizontal.

For example, determining the plane may include determining a surface intersecting or capturing the total flow of the emitted gas, such as the cross-section 64. In one or more embodiments, the cross-section can be determined without using additional atmospheric information, and a general boundary of the facility where the source of emission is likely present is used. The cross-section 64 may encircle the entire facility to make sure all of the flux is captured. In some instances, such as after the initial rise due to buoyancy and momentum, the emission plume 18 may travel primarily in a horizontal direction as illustrated in FIG. 4. Thus, the encircling surface may only need to have a sufficiently high vertical section all the way around the possible emission source, like a wall surrounding an area. The cross-section can have any sufficient arbitrary shape, such for example, a circular or rectangular shell with an open top, shown in the FIGS. 3A and 3B.

Accordingly, it may advantageous to determine a height of the cross-section 64 such that all of the pollutant plume goes through that surface and none passes above. For example, the diameter or lateral extent of the cross-section 64 should be large enough to ensure the emission plume 18 has become fully horizontal with minimal continued rise, to ensure there is minimal flux through the top of the cross-section 64 which is not measured. There are a number of atmospheric models available for estimating plume rise heights (e.g., S. R. Hanna, G. A. Briggs, R. P. Hosker, 1982, Handbook on Atmospheric Diffusion, DOE/TIC-11223). However, such techniques may have certain limitations due to the time scale for obtaining measurements. First, the techniques may include encircling the entire perimeter of the facility which could take a relatively long time, putting constraints on the carrier technology. Second, if the time to circle around the perimeter is long, there is an increased chance of the wind shifting and the emission plume 18 changing direction, resulting in under or overcount of the flux. The disclosed techniques may reduce the timescale for obtaining and processing optical measurements, and thus provide meaningful information (e.g., whether a concentration of gases is sufficiently high that an area should be evacuated) of the properties of the emission plume 18 before the emission plume has significantly changed or diffused into a surrounding environment.

In certain embodiments, the process 90 uses additional atmospheric information to delineate the extent of the emission plume 18 and with a much smaller surface that does not fully enclose all the potential emission sources but fully intersects the cross-section of the emission plume 18, capturing all of the flux. In such embodiments, a determination of the emission plume direction, rise and spread are first estimated based on atmospheric data and likely emission source location. There are a number of methods for doing this covered in extensive literature on the atmospheric science of pollutant dispersion. One commonly used model is the Gaussian Plume Model (GPM) which is the engine in AERMOD, the EPA's preferred regulatory pollutant dispersion model. Various factors will affect plume formation and transport ranging from wind direction and speed, atmospheric stability and cloud cover, terrain topology, to the presence of inversion layers. Accordingly, the process 90 may use atmospheric measurements, such as the wind speed and direction at a minimum, and additional measurement such as solar radiation enhancing the accuracy of the GPM prediction. Once the rough plume location and flow direction have been identified by the process 90, the cross-section intersecting the emission plume 18 can be easily defined. It does not need to close on itself, it can be just a plane slicing through the emission plume 18 cross-section 64. As the emission plume 18 width might be relatively small (e.g., 20-30 degrees), the time used to scan its cross-section could be an order of magnitude less than scanning the full 360 facility perimeter. As such, it may not be necessary to scan the entire surface boundary of the facility to provide an accurate determination of the flux of the emission plume 18.

Once the cross-section 64 (e.g., the plume-intersecting surface) has been chosen or determined, the processor 34 may estimate the total flux of the pollutant of interest (e.g., CH₄ or CO₂) through that surface. After the initial rise, the emission plume 18 will travel primarily in a horizontal direction (e.g., the direction 59). The trajectory of the mobile LiDAR system, which can utilize an aircraft- or vehicle-mounted LiDAR system, can be set to go over the emission plume 18 and along the edge of the cross-section 64. In one embodiment, the laser and detector of the light detection unit 16 may be pointing directly down towards the ground, such that the laser beam scans the entire line of the pre-selected surface. In other embodiments, the laser and detector the light detection unit 16 can be angled, same as the source-enclosing or plume-intersecting surface. The LiDAR measurement will deliver the total amount of methane or CO₂ along the path of the emitted beam. Thus, an individual measurement integrates the total methane or CO₂ concentration over a line across the emission plume 18. The next measurement along the vehicle 11 trajectory will give the total concentration along the adjacent line. If the integrated concentration value of the ith measurement is Cᵢ, the spacing between the ith and (i+1)st beam lines is Dyᵢ and the vector normal to the cross-section 64 (e.g., enclosing surface) at the location of the beam is nᵢ, and the wind vector measured at the time is vᵢ, the contribution of the ith bin to the flux through the cross-section 64 is Fᵢ=CᵢDyᵢ vᵢ·nᵢ. As the vehicle 11 mounted LiDAR system traverses the top edge of the cross-section 64, scanning each vertical line, it will measure the total flux as the sum of all the contribution of all vertical bins (e.g., each optical measurement along an optical measurement vector 82) defining the cross-section 64, F=SᵢFᵢ.

In order to implement these workflows, the LiDAR carrier may be equipped with a GPS unit recording the sensor location and time stamp of each measurement so that the correct unit normal to the cross-section 64 can be obtained. Similarly, a wind measurement may be available in order to set the direction of the flow of the concentration through the cross-section 64 and compute the term vᵢ·nᵢ for each flux bin. For example, the vehicles 11 may be equipped with an anemometer. As such, the processor 34 may utilize a wind speed measurement to determine the location of the cross-section 64, the height where the emission plume 18 becomes substantially horizontal, and the like. At least in some instances, the wind measurement may be as close as possible to the trajectory of the vehicle 11 (e.g., aerial vehicle 12) with the understanding that the instantaneous wind at sensor location will differ from the measurement at the anemometer. However, over time scales of the scanning operation which could take 10s of minutes, the mean wind should be uniform over 100's to 1000's of meters, averaging out local turbulent eddies, and averaging out the concentration fluctuations as well. Small wind fluctuations will not significantly impact the flux computation. A large wind direction change occurring in the course of the measurement, however, will impact the flux computation. Therefore, as part of the process 90, prejob planning may be performed and a suitable time period for conducting the measurement may be selected by the process 90. The forecast may be stable and wind conditions such that a steady plume is likely to form. Winds that are relatively weak or too shifting in direction may cause the emission plume 18 to disperse rapidly and, at least for methane, to rise up high due to density difference rather than forming a steady horizontal plume for the application of this technique.

At block 96, the processor 34 may determine a travel path 60 for an optical detector to obtain measurements along the plane (e.g., the cross-section of the emission plume 18 that is included in the plane). In general, the travel path 60 corresponds to a direction along a plane that is crosswise to a direction of a flow of a gas emission. For example, the travel path 60 may be crosswise to the second direction 59 as described in FIG. 4.

In some embodiments, the travel path 60 may include multiple instructions for obtaining multiple optical measurements along different viewpoints, different perspectives, and/or different angles relative to the emission plume 18. For example, the travel path 60 may indicate that a vehicle 11 to obtain a first optical measurement data (e.g., a single optical measurement or multiple optical measurements along a direction) such that the light detection unit 16 obtains the measurements at a first angle (e.g., less than 90°, less than 80°, less than 70°, less than 60°, less than 45°, or less than 30°) relative to a normal of the ground. Further, the travel path 60 may indicate that the vehicle 11 (e.g., or a different vehicle) to obtain a second optical measurement data (e.g., a single optical measurement or multiple optical measurements along a direction) such that the light detection unit 16 obtains the measurements at a second angle (e.g., less than 90°, less than 80°, less than 70°, less than 60°, less than 45°, or less than 30°) relative to a normal of the ground. Further still, the travel path indicate that the vehicle 11 (e.g., or a different vehicle) to obtain a third optical measurement data (e.g., a single optical measurement or multiple optical measurements along a direction) such that the light detection unit 16 obtains the measurements at a third angle (e.g., less than 90°, less than 80°, less than 70°, less than 60°, less than 45°, or less than 30°) relative to a normal of the ground. It should be noted that obtaining multiple optical measurements at different angles may be used by the processor 34 to assemble three dimensional (3D) image data of the properties of the emission plume. Accordingly, the processor 34 may output instructions that cause one or more of the vehicles 11 to obtain optical measurements in accordance with the travel path(s) 60.

FIG. 7 is flow diagram of an embodiment of a process 100 for generating an emission plume property output (e.g., image data depicting the properties of the emission plume 18 in the cross-section 64) based on optical measurements, as a further illustration of operation of the components of the emission plume monitoring system 30 described in FIG. 2. Although the process 100 is described as being performed by the processor 34, any suitable machine or processor-based device capable of communicating with other components of the system 10 may perform the disclosed process 100 including, but not limited to, the processor 42, and the like. At least in some embodiments, the processor 34 may perform the process 100 with one or more blocks omitted or in a different order.

At block 102, the processor 34 may receive a travel path 60 for an optical detector to obtain measurements along a plane. In general, the processor 34 may determine a travel path 60 as described with respect to block 96 or receive the travel path 60 from an external controller or processor.

At block 104, the processor 34 may instruct a controller of an unmanned aerial vehicle (e.g., aerial vehicle 12) to execute the travel path 60 and obtain optical measurements associated with the emission plume. In general, the processor 34 may output a control signal that indicates the travel path 60. Additionally, the control signal may indicate an altitude or relative height of the travel path 60 relative to the ground.

At block 106, the processor 34 may receive the optical measurements. In general, prior to receiving the optical measurements, the processor 34 may output a control signal that causes one or more vehicles 11 to obtain the optical measurements. In some embodiments, the control signal may indicate a frequency, step size, or distance between measurements. For example, the control signal may indicate that the aerial vehicle 12 should record optical measurements every 5 seconds (s), 10 s, 15 s, 20 s, 30 s, or more than 30 s.

At block 108, the processor 34 may determine one or more properties of the emission plume based on the optical measurements. In general, the one or more properties may include an absorption at different positions along an optical measurement vector 82. By determining the absorption or other optical property at the different positions of multiple optical measurement vectors 82, the processor 34 may determine a cross-section 64 indicative of the concentration of chemical species in the emission plume and/or flux of the chemical species. In some embodiments, the one or more properties may include the total concentration of species within the cross-section 64.

At block 110, the processor 34 may generate an emission plume property output based on the determined one or more properties. In general, the emission plume property output may be an alert or a control signal that adjusts an operation of certain components of the facility 20. For example, the processor 34 may determine that the flux of the gas through the cross-section 64 is above or below a threshold concentration. As such, the processor 34 may output a visual or audio alert indicating that the flux exceeds or is below the threshold concentration. As another non-limiting example, the processor 34 may output a control signal that adjust operation of equipment within the facility, such as closing one or more valves or doors to block further leakage, opening windows, vents, or turning on fans to facilitate the diffusion of the emission plume 18.

In some embodiments, the emission plume property output may include a control signal that causes an adjustment to a position and/or tilt (e.g., angular offset) of a camera, light detector, or illumination source of the light detection unit 16. It should be noted that this may aid in proper detection of the properties of the emission plume 18. For example, the processor 34 may utilize a real time combination of object recognition and the computation of occluded areas to generate the adjustment (e.g., positional adjustment). As such, the adjustment may position the light detection unit 16 (e.g., visual or audible instructions for a user to implement and/or automatic adjustment by the processor 34) for maximum coverage of objects of interest. As such, the techniques may provide real-time a positioning of greenhouse emission detectors based on occlusion information and objects of interest.

In some embodiments, the emission plume property output may include using a three-dimensional (3D) model and/or an adjustment to an existing 3D model. For example, the processor 34 may generate image data using the optical measurements that indicates one or more properties (e.g., absorption and/or concentration of one or more chemical species) of the emission plume 18. Further, the processor 34 may utilize additional models (e.g., computational fluid dynamic (CFD) models) to generate an improved image data that may further aid an operator in assessing the properties of the emission plume 18.

In some embodiments, the emission plume property output may include a control signal that causes the vehicles 11 to obtain additional optical measurements that provide a more detailed survey to identify the source of the emissions. For example, the one or more properties may include an emission flux. As such, the processor 34 may compare the emission flux to an emission flux threshold (e.g., predetermined emission-flux threshold). If the measured emission flux (e.g., the one or more properties) is above the emission-flux threshold and/or outside of an emission-flux threshold range, the processor 34 may generate and output an emission plume property output that causes the vehicles 11 to obtain additional optical measurements. For example, the emission plume property output may cause one or more vehicles 11 to obtain optical measurements at additional positions and/or angles relative to the emission plume 18, thereby providing coverage of a relatively larger area of the emission plume 18. That is, the emission plume property output may include instructions for the one or more unmanned aerial vehicles to obtain additional optical measurements of additional regions of the emission plume that may not have been covered by the previous measurements. For example, the processor 34 may instruct a vehicle 11 to obtain one or more additional measurements along an additional flight path different from the flight path received at block 102. Additionally or alternatively, the emission plume property output may cause the vehicles to repeat one or more optical measurements along the flight path. In some embodiments, the emission plume property output may cause the vehicles to repeat one or more optical measurements along the flight path with different parameters, such as acquiring more or fewer optical measurements (e.g., higher resolution optical measurements), with a positional adjustment, and other variations to parameters related to obtaining the optical measurements. In any case, the disclosed techniques may be used to perform an initial optical measurement, such as a screening measurements, and subsequently perform more thorough analysis based on the screening measurements. In this way, the processor 34 may adjust parameters for locating a cause of a greenhouse gas emission.

In some embodiments, if the processor 34 determines that the one or more properties are below the emission-flux threshold and/or inside of an emission-flux threshold range, the processor 34 may generate and output emission plume property output that causes the vehicle 11 and/or additional vehicles (i.e., which may be actively or in the process of measuring optical measurements) to stop obtaining optical measurements, or otherwise halt operation.

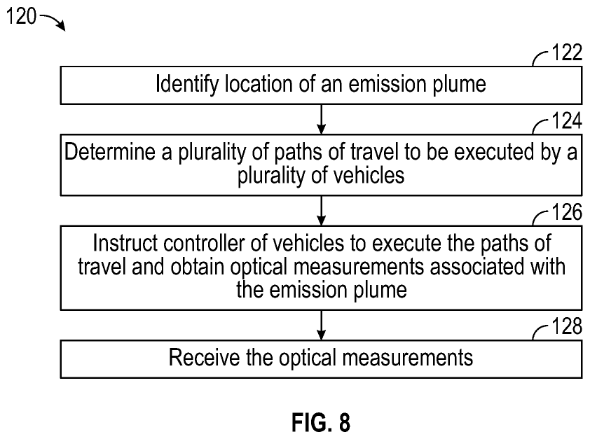

FIG. 8 is a flow diagram of an embodiment of a process 120 for instructing multiple vehicles to obtain optical measurements, as a further illustration of operation of the components of the emission plume monitoring system 30 described in FIG. 2. Although the process 120 is described as being performed by the processor 34, any suitable machine or processor-based device capable of communicating with other components of the system 10 may perform the disclosed process 120 including, but not limited to, the controller 110, and the like. At least in some embodiments, the processor 34 may perform the process 120 with one or more blocks omitted or in a different order.

At block 122, the processor 34 may identify a location of an emission plume (e.g., emission plume 18). In general, the processor 34 may perform block 122 in a generally similar manner as described with respect to block 94. For example, the location may include a height where the emission plume 18 begins to travel substantially horizontal. Additionally or alternatively, the location may include coordinates of a cross-section 64 (e.g., an altitude, GPS coordinates, and the like) of the emission plume 18.

At block 124, the processor 34 may determine a plurality of travel paths 60 to be executed by multiple vehicles 11. In general, the processor 34 may perform block 124 in a generally similar manner as described within respect to block 104, but for multiple paths of travel and/or multiple vehicles 11.

In some embodiments, the process 120 may be used to adjust travel paths 60. For example, the processor 34 may receive image data, optical measurements, and/or data associated with the emission plume 18 that may be used to determine an adjustment to the travel path 60. For example, the processor 34 may receive weather data (e.g., a wind speed), gas property data (e.g., a composition of the emission plume), or other data may be useful in determining that travel paths 60 should be adjusted. Accordingly, the processor 34 may determine an adjustment to the travel path 60, such as increasing or decreasing a viewpoint of orientation of the vehicle and/or light detection unit 16, an angle of the measurement, adding an additional flight path, or flying over a different area (e.g., in an embodiment where the gas plume may be moving more quickly or more slowly than previously determined).

In some embodiments, the vehicle 11 might be deployed to survey a large number of sites. In this case, the vehicle 11 would depart from one location, fly over one site in accordance with a first travel path 60, emit the laser down from the vehicle 11 to the site, measure the laser light returning from the site to the single photon detector (e.g., light detector unit 16) to determine the methane emissions, then the vehicle 11 may fly to the next site and execute a second travel path 60. After measuring one or multiple sites, the vehicle 11 would land. The vehicle 11 could fly an optimized route, as described in PCT Application published under No. WO 2020/018867. This system might be of interest if the vehicle 11 is operated beyond a visual line of sight, which would reduce the cost of piloting the vehicle 11. With that approach, the system would be less expensive than a traditional LiDAR system mounted on a manned aircraft.

In some embodiments, the vehicle 11 might be deployed to continuously monitor emissions from one facility using multiple travel paths 60 (e.g., the same travel path 60 but performed multiple times). It should be noted that continuous monitoring may provide a technical advantage that it captures intermittent emissions that might not be captured by snapshot survey detection as described above. As a LiDAR system may utilize a reflected background to reflect the light source (e.g., a laser), the system cannot measure effectively if the laser is pointed at the sky. In certain embodiments, the laser might be mounted to a vehicle 11 to give it an appropriate elevated position with a good imaging background. In certain embodiments, the vehicle 11 might be set back an appropriate distance from the location to optimize distance and field of view. The vehicle 11 could be operated in a way that it would fly for some period and then recharge, or it could be operated in tethered mode such that it could remain operating for extended durations. With this approach, the system would be more widely applicable than a traditional LiDAR system mounted on a mast.

In certain embodiments, the systems mobile object might be one or a plurality of ground robot(s) that move using wheels, tracks, or legs so called Unmanned Ground Vehicles (UGVs), such as the land vehicles 14. This has the advantage of reduced safety and regulatory concerns and reduced power consumption and thus longer potential lifetimes as opposed to flying objects, such as aerial vehicles 12.

The intrinsic capability of a single photon time of flight-based sensor to measure distances to the reflective target (e.g., the ground or infrastructure in the case of aerial transport such as vehicle 11s) enables to generate a 3D model/point cloud representation of the world simultaneously with the methane measurements. This may reduce time to acquire the measurements and process the optical measurements. Further still, this may increase the accuracy in generating both methane measurements and 3D models as they would be simultaneously recorded and geospatially localized. Furthermore, this combination can be used to increase the accuracy of leak source quantification and localization by accounting for wind field fluctuations due to three-dimensional obstacles. Depending on the geometry, these can result in increased turbulent mixing, downwash causing methane to be driven downwards after passing over a tank or other large structure, as well as in general significantly changing the shape of the methane plume. To do so, the 3D model may be utilized in a Computational Fluid Dynamics or other simulation to predict the actual wind fields rather than just an average one as observed by the vehicle 11 or other meteorological station nearby. Additionally, by utilizing the generated 3D model, in embodiments, a visualization can be presented that accurately shows in 3D where the methane leak is detected. This may aid operators in rapidly fixing that leak by reducing the amount of time to find the leak as well as aid in the creation of virtual inspection tags and/or physical inspection tags that includes the 3d model of the equipment. The approach can also highlight differences in equipment and layout of the site over time that can aid in understanding the nature and origin of a leak. Lastly, by utilizing the information in the 3D model, an optimized travel path 60 might be planned and then adapted in real-time based on the equipment discovered to ensure that emissions from the entire facility would be properly detected as well as that the travel path 60 would not encounter any obstacles. In certain embodiments, a further optimization might be done to ensure that a given travel path 60 takes the minimal amount of time/energy while still ensuring proper coverage, for example, by utilizing a real time combination of object recognition and the computation of occluded areas for maximum coverage of objects of interest.

In addition, the added degrees of freedom created by utilizing a vehicle 11 (e.g., an unmanned vehicle 11 controlled remotely) to move the methane single photon system in a controlled manner enable the reconstruction of actual plume dimensions from the integral concentrations produced by the sensor. In embodiments, the light detection unit 16 may record multiple optical measurements of the emission plume 18 from different angles such as at 300 to the emission plume 18, 450 to the emission plume, 60° to the emission plume 18, or 900 to the emission plume 18. Then, by using the methodology of tomography, a best estimate of the methane concentration at a voxel in space might be inferred providing a full 3D reconstruction of the emission plume 18.

Finally, in certain embodiments, deploying mobile, UGV, fixed ground or vehicle 11 carried laser retroreflectors, mirrors or reflective surfaces can ensure coverage and good signal path in all environments, including offshore. It enables for example flying vehicles 11 in pairs in various trajectories, one of which could be a “double helix”, or “scan pattern” to improve the previously mentioned method of tomography and enable its application in other settings where one vehicle 11 is tracking the other using the LiDAR beam, the other carries a retroreflector, while both follow pre-programmed trajectories that are designed to optimally cover the area of interest. In certain embodiments, retroreflectors or mirrors might be permanently installed in suitable locations in areas that are normally difficult to map, such as offshore installations. Utilizing retroreflectors also enables increased or maximum signal quality.

In some embodiments, the processor 34 may determine complementary travel paths 60 for multiple vehicles. For example, the processor 34 may determine a first travel path 60 for a first aerial vehicle 12 to travel and emit light. The processor 34 may also determine a second travel path for a second aerial vehicle 12 to travel and detect the light emitted by the first aerial vehicle 12 (e.g., the light detection unit 16 of the first aerial vehicle 12 may provide a light source and the light detection unit 16 of the second aerial vehicle 12 may provide a light detector). Alternatively, the second aerial vehicle 12 may include a reflective surface (e.g., a retroreflective surface or other reflective surface), and thus, the second travel path may enable the reflective surface 24 to reflect the emitted light by the first aerial vehicle 12 back towards the first aerial vehicle 12.

At block 126, the processor 34 may instruct one or more controllers of unmanned vehicles to execute the travel path and obtain optical measurements associated with an emission plume. In general, the processor 34 may perform block 126 in a generally similar manner as described in block 104 of FIG. 7.

At block 128, the processor 34 may receive the optical measurements. In general, the processor 34 may utilize the optical measurements to determine an emission plume property output in a generally similar manner as described in block 110 of FIG. 7.

In this way, the disclosed techniques may enable multiple vehicles 11 to operate in a cooperative or continuous manner to obtain optical measurements that utilize less computational resources that certain optical measurement obtained by conventional techniques.

This written description uses examples to disclose the subject matter, including the best mode, and also to enable any person skilled in the art to practice the subject matter, including making and using any devices or systems and performing any incorporated methods. The patentable scope of the subject matter is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method, comprising:
receiving an indication of an emission plume traveling along a first direction;
determining a cross-section of the emission plume, wherein the cross-section is substantially perpendicular to the first direction; and
determining a travel path for an optical detector to obtain optical measurements along the cross-section, wherein the travel path extends in a second direction along the cross-section, and the optical detector is configured to obtain the optical measurements in a third direction crosswise to the travel path.

2. The method of claim 1, wherein determining the cross-section comprises determining a height of the emission plume, and wherein the optical detector is configured to obtain the optical measurements approximately along the height of the emission plume.

3. The method of claim 1, wherein the optical measurements comprise light detection and ranging (LiDAR) measurements.

4. The method of claim 1, comprising determining an emission rate of the emission plume based on the optical measurements.

5. The method of claim 1, wherein the first direction is substantially horizontal relative to a ground below the emission plume.

6. The method of claim 1, comprising outputting a control signal to a controller of one or more unmanned vehicles to execute the travel path.

7. The method of claim 6, comprising outputting an additional control signal to the controller of the one or more unmanned vehicles to obtain the optical measurements along the travel path.

8. The method of claim 7, comprising:
receiving the optical measurements obtained by the one or more unmanned vehicles; and
generating an emission plume property output based on the optical measurements.

9. A system, comprising:
one or more vehicles; and
a processor configured to instruct one or more vehicles to:
execute a travel path along a length of a cross-section of an emission plume; and
obtain optical measurements along a width of the cross-section during the travel path; and
receive the optical measurements; and
determine an emission rate corresponding to the emission plume based on the optical measurements.

10. The system of claim 9, wherein the emission rate corresponds to a flux of a chemical species through a cross-section spanning the travel path.

11. The system of claim 9, wherein the travel path is substantially parallel to a ground below the one or more vehicles.

12. The system of claim 9, wherein the one or more vehicles comprise one or more unmanned aerial vehicles comprising a light detection unit to obtain the optical measurements.

13. The system of claim 9, wherein the one or more vehicles comprise a land vehicle having a mast, wherein a light detection unit is disposed at an elevated location on the mast.

14. A system, comprising:
one or more unmanned vehicles;
a processor configured to:
receive an indication of an emission plume traveling along a first direction;
determine a cross-section corresponding to a cross-section of the emission plume, wherein the cross-section is substantially perpendicular to the first direction;
instruct a controller of the one or more unmanned vehicles to:
execute a travel path along a length of the cross-section; and
obtain optical measurements along a width of the cross-section during the travel path; and
receive the optical measurements; and
generate an emission plume property output indicative of a concentration of one or more gases within the emission plume.

15. The system of claim 14, wherein the one or more unmanned vehicles comprise an unmanned aerial vehicle comprising a light detection and ranging (LIDAR) detection unit.

16. The system of claim 14, wherein the travel path is substantially parallel to a reflective surface.

17. The system of claim 14, wherein the one or more unmanned vehicles comprise an unmanned aerial vehicle comprising a reflective surface.

18. The system of claim 14, wherein the processor is configured to:
instruct a first unmanned aerial vehicle to execute the travel path; and
instruct a second unmanned aerial vehicle to execute an additional travel path complementary to the travel path.

19. The system of claim 14, wherein the emission plume property output comprises a positional adjustment for one or more light detector units of the one or more unmanned aerial vehicles.

20. The system of claim 14, wherein the emission plume property output comprises instructions for the one or more unmanned aerial vehicles to obtain additional optical measurements of additional regions of the emission plume.
